(19) United States
(12) Patent Application Publication
(10) Pub. No.: US 2024/0203047 A1
(43) Pub. Date: Jun. 20, 2024

(54) SIMULATING DIGITAL TWINS IN A VIRTUAL REALITY ENVIRONMENT

(71) Applicant: International Business Machines Corporation, Armonk, NY (US)

(72) Inventors: Fang Lu, Billerica, MA (US); Jeremy R. Fox, Georgetown, TX (US); Sarbajit K. Rakshit, Kolkata (IN); Tushar Agrawal, West Fargo, ND (US)

(73) Assignee: International Business Machines Corporation, Armonk, NY (US)

(21) Appl. No.: 18/081,666

(22) Filed: Dec. 14, 2022

(51) Int. Cl. G06T 17/00

(52) U.S. Cl. CPC G06T 17/00

(57) ABSTRACT

A method establishes a virtual reality environment for simulating operation of the digital twin model and operates the digital twin model in the virtual reality environment. The digital twin model receives operational parameters from the virtual reality environment in order to determine operational effectiveness of the digital twin model in operating within the virtual reality environment. The method further enables a user to visualize the operation of the digital twin model in the virtual reality environment. In certain embodiments, the method provides a second digital twin model of a second physical object and operates the second digital twin model in the virtual reality environment along with the first digital twin model. This may enable assessment of the interaction between the two digital twin models and/or how operation of one digital twin model may affect operation of the other digital twin model. A corresponding system and computer program product are also disclosed.

### BACKGROUND

### Field of the Invention

This invention relates to systems and methods for simulating digital twin models in virtual reality environments.

### Background of the Invention

A digital twin is a virtual model that is generated to reflect an existing physical object. The physical object may be fitted with sensors that produce data about different aspects of the object's performance. For example, the physical object may be a wind turbine outfitted with various sensors to collect data about different aspects of the wind turbine. This data is then relayed to a processing system and applied to the digital twin model. This digital model, or twin, may then be used to run simulations, study current performance, and generate potential improvements that can then be applied back to the actual physical asset. A digital twin model may also be created for non-physical processes and systems, mirroring the actual processes or systems and enabling simulations to be run based on real-time data.

The data that is associated with digital twin models is usually collected from Internet-of-Things (IOT) enabled devices, thereby enabling the capture of high-level information that may then be integrated into the digital twin model. A digital twin is, in effect, a virtual object where ideas can be tested with few limitations. With an IoT platform, the digital twin model becomes an integrated, closed-loop system that can be used to inform and drive strategy across a business.

### SUMMARY

The invention has been developed in response to the present state of the art and, in particular, in response to the problems and needs in the art that have not yet been fully solved by currently available systems and methods. Accordingly, systems and methods have been developed for simulating digital twin models in virtual reality environments. The features and advantages of the invention will become more fully apparent from the following description and appended claims, or may be learned by practice of the invention as set forth hereinafter.

Consistent with the foregoing, a method in accordance with the invention includes providing a digital twin model of a physical object. The method establishes a virtual reality environment for simulating operation of the digital twin model and operates the digital twin model in the virtual reality environment. The digital twin model receives operational parameters from the virtual reality environment in order to determine operational effectiveness of the digital twin model in operating within the virtual reality environment. The method further enables a user to visualize the operation of the digital twin model in the virtual reality environment. In certain embodiments, the method provides a second digital twin model of a second physical object and operates the second digital twin model in the virtual reality environment along with the first digital twin model. This may enable assessment of the interaction between the two digital twin models and/or how operation of one digital twin model may affect operation of the other digital twin model.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level diagram showing one embodiment of a digital twin representing a physical object;

FIG. 3 is a high-level diagram showing insertion of the digital twin in a virtual reality environment;

FIG. 4 is a high-level diagram showing insertion of multiple digital twins in a virtual reality environment;

FIG. 5 is a flow diagram showing one embodiment of a process for simulating a digital twin within a virtual reality environment;

FIG. 6 is a flow diagram showing a process for setting up a digital twin within a virtual reality environment and then simulating the digital twin within the environment; and

FIG. 7 is a high-level block diagram showing a digital twin simulation module in accordance with the invention and various sub-modules that may be included therein.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “digital twin simulation module 150”) associated with simulating a digital twin within a virtual reality environment. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

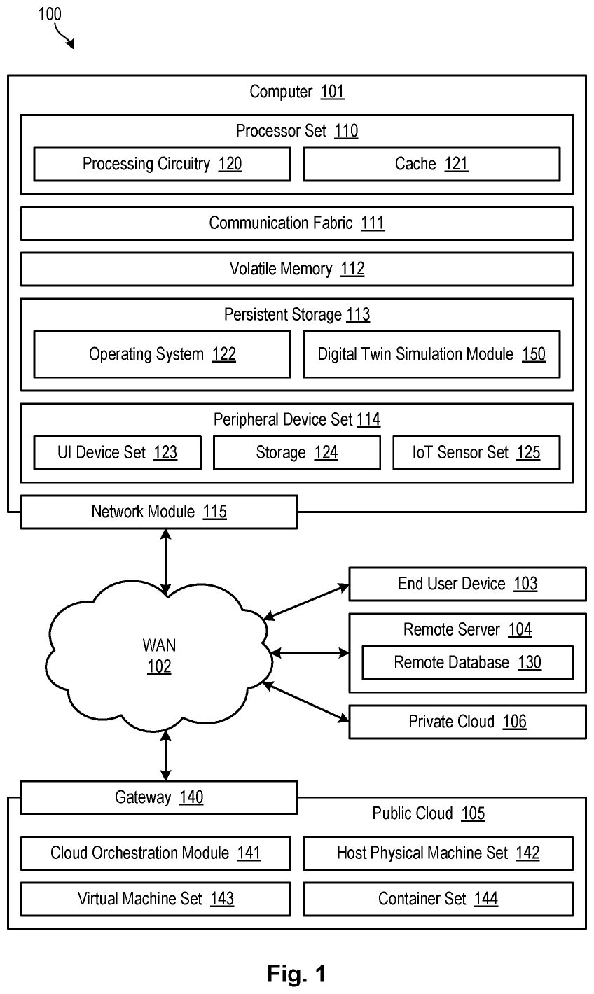

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

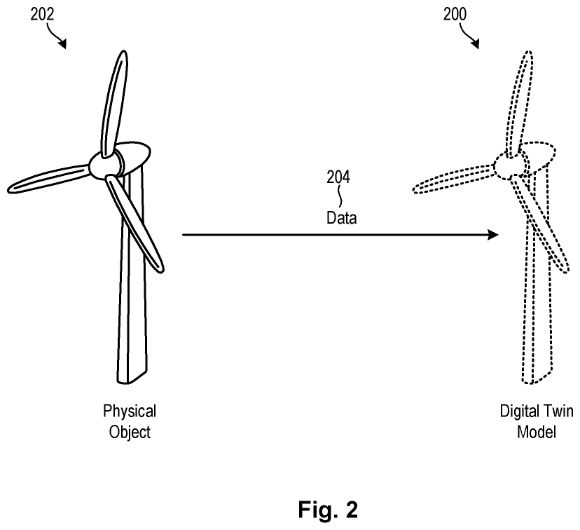

Referring to FIG. 2, as previously mentioned, a digital twin 200 is a virtual model that is created to reflect an existing physical object 202. The physical object 202 may be fitted with sensors that produce data about different aspects of the object's performance. For example, as shown in FIG. 2, the physical object 202 may be a wind turbine outfitted with various sensors to collect data 204 about different aspects of the wind turbine. This data 204 may then be relayed to a processing system and applied to the digital twin model 200. This digital model 200, or twin, can then be used to run simulations, study current performance, and generate potential improvements that can then be applied back to the actual physical asset 202. A digital twin model 200 may also be created for non-physical processes and systems, mirroring the actual processes or systems and enabling simulations to be run based on real-time data.

The data 204 that is related to digital twin models 200 is typically collected from Internet-of-Things (IOT) enabled devices, thereby enabling the capture of high-level information which may then be integrated into the digital twin model 200. A digital twin 200 is, in effect, a virtual object where ideas can be tested with few limitations. With an IoT platform, the digital twin model 200 becomes an integrated, closed-loop system that can be used to inform and drive strategy across a business.

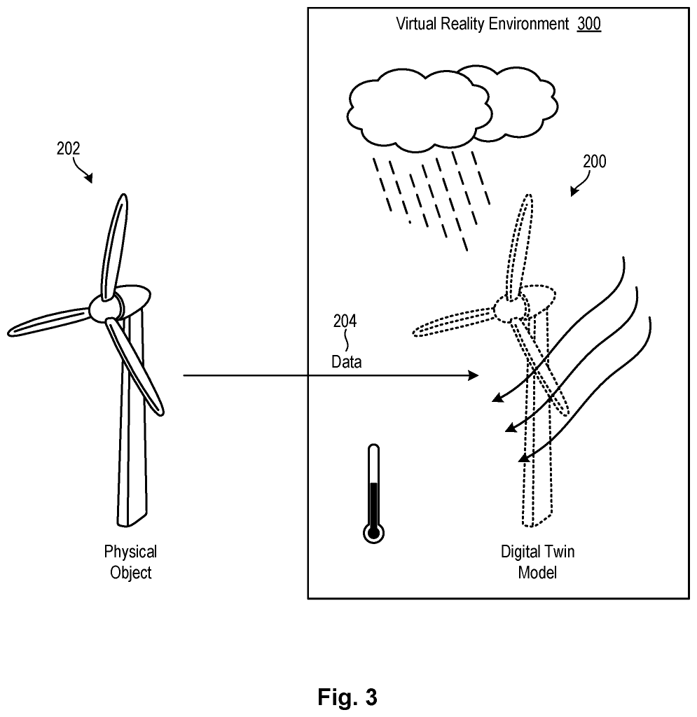

Referring to FIG. 3, in certain cases, more information may be desired for a physical asset 202, such as how the physical asset 202 would perform in various types of environments. In some cases, simulating the digital twin model 200 in a virtual environment is substantially easier and/or more cost effective than simulating the corresponding physical object 202 in a real-world environment. Furthermore, it would be advantageous to be able to test a digital twin model 200 in various different virtual environments before deploying the corresponding physical object 202 in a real-world environment. This may assist in learning in which real-world environments the physical object 202 will perform best, or how the physical object 202 will respond or perform in response to various real-world conditions.

In certain embodiments, a system and method in accordance with the invention may enable a digital twin 200 to be inserted into a virtual reality environment 300 to determine how the digital twin 200 will perform in the virtual reality environment 300. The digital twin 200 may be configured to receive operational parameters from the virtual reality environment 300 to determine how the digital twin 200 will perform in response to various conditions in the virtual reality environment 300. Ideally, this will enable a user to determine how the corresponding physical object 202 will perform in a real-world environment that roughly corresponds to the virtual reality environment 300.

For example, assuming the digital twin 200 represents a wind turbine, the digital twin 200 may be placed in a virtual reality environment 300 with different operational parameters, such as different temperature, wind speed, wind direction, wind characteristics (gusts, variations or changes in the speed and direction, etc.), precipitation types and magnitude, snow and/or ice accumulations on the blades of the wind turbine, humidity, etc. In certain embodiments, a user may select the operational parameters that are to be used in the virtual reality environment 300 or vary the operational parameters to simulate different types of environments.

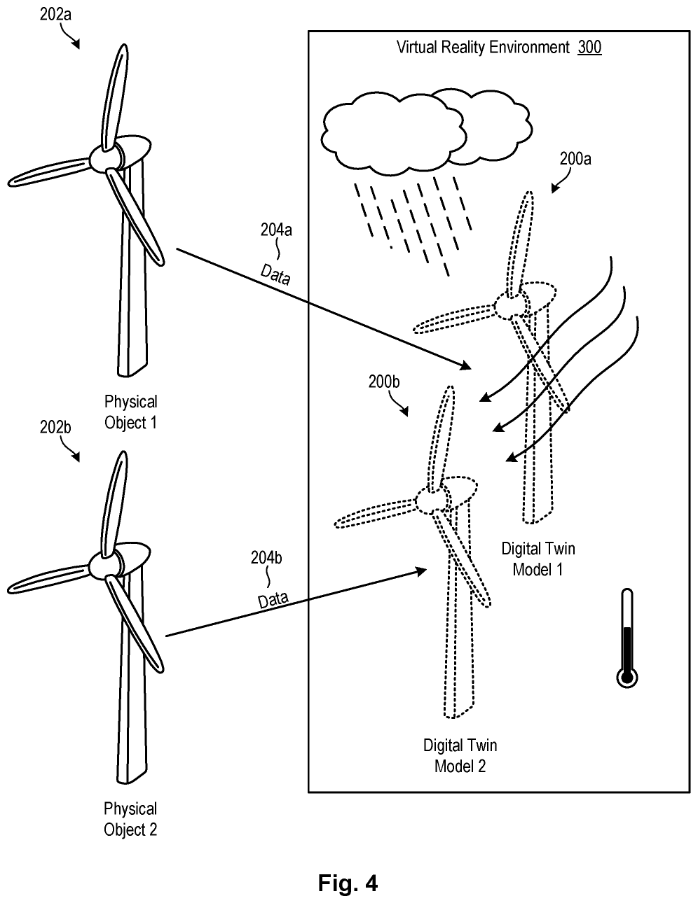

Referring to FIG. 4, in many real-world environments, a physical object 202 is not acting in isolation. For example, in some cases, a physical object 202 may operate in the presence of other physical objects 202. In some cases, the operation of one physical object 202 may affect or be affected by the operation of another physical object 202. For example, the output of one physical object 202 may provide the input to another physical object 202. Or one physical object 202 may affect the input to another physical object 202. For example, if the physical object 202 is a wind turbine that is upstream from another wind turbine, the first wind turbine may affect the wind speed or wind direction that is incident on the other downstream wind turbine.

In order to model or simulate the interaction of multiple physical objects 202 in a real-world environment, in certain embodiments, multiple digital twins 200 may be inserted into a virtual reality environment 300, as shown in FIG. 4. This may enable the digital twins 200 to be subjected not only to the operational parameters of the virtual reality environment 300, but also to the effects that each digital twin 200 may have on the other. For example, as shown in FIG. 4, in certain embodiments, the wind speed or direction that is incident on a second digital twin 200b may affect or be affected by a first digital twin 200a that is upstream from the second digital twin 200b. Such a simulation may be effective to determine how to position wind turbines in a real-world environment in order to minimize the negative effects between wind turbines, or to increase their synergism. In certain contemplated embodiments, an entire fleet of physical assets 202 (such as an entire farm of wind turbines) may be simulated together in the virtual reality environment 300 to simulate how they function together.

In certain embodiments, the digital twins 200a, 200b that are modeled in the virtual reality environment 300 may each correspond to different physical objects 202a, 202b, as shown in FIG. 4. In other embodiments, the digital twins 200a, 200b may both correspond to the same physical object 202. In other words, digital twins 200a, 200b that are duplicate copies of one another may be modeled together to see how one affects the other in the virtual reality environment 300. This may be helpful in modeling a fleet of identical or similar physical assets 202. In some embodiments, the multiple digital twins 200a, 200b are identical to one another. In other embodiments, the digital twins 200a, 200b are different from one another. For example, using the wind turbine example provided above, it may be desirable to compare performance of a first type of wind turbine against the performance of a second type of wind turbine in a virtual reality environment 300 to see how the different types of wind turbines might perform in the same environment. In other use cases, digital twins 200 of multiple different pieces of machinery (such as multiple machines on a factory floor that are involved in a manufacturing process) may be modeled or simulated together to determine process-level efficiency or performance of the multiple machines.

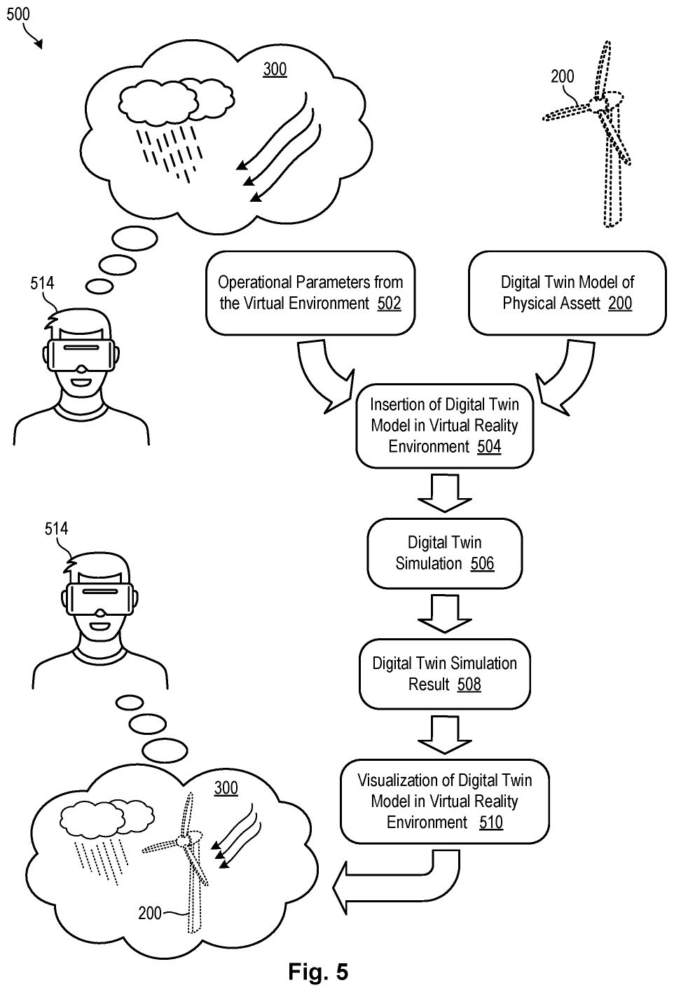

Referring to FIG. 5, one embodiment of a process 500 for simulating a digital twin 200 within a virtual reality environment 300 is illustrated. As shown, a virtual reality environment 300 may be provided or generated. In certain embodiments, this virtual reality environment 300 may be characterized by selected operational parameters 502. These operational parameters 502 may, in certain embodiments, be set or controlled by a user 514. As shown, in certain embodiments, the user 514 may be able to visualize the virtual reality environment 300 with the selected operational parameters 502 using a virtual reality device, such as a virtual reality headset. This virtual reality device may enable the user to turn, look around, or move from one place to another within the virtual reality environment 300.

As further shown in FIG. 5, a digital twin model 200 of a physical asset 202 may be provided or generated. The method 500 may enable injection or insertion 504 of the digital twin model 200 into the virtual reality environment 300 to simulate 506 the digital twin model 200 in the virtual reality environment 300 under the specified operational parameters 502. This may yield a simulation result 508 which may, in certain embodiments, indicate how the digital twin model 200 performed in the virtual reality environment 300. The process 500 may further enable visualization 510, by the user 514, of the digital twin model 200 in the virtual reality environment 300 using a virtual reality device such as the virtual reality headset described above. In certain embodiments, this may enable the user to visualize and view the simulation of the digital twin 200 in the virtual reality environment 300, including potentially moving around and viewing the digital twin 200 and virtual reality environment 300 from different angles and from different locations within the virtual reality environment 300 before, during, or after the simulation.

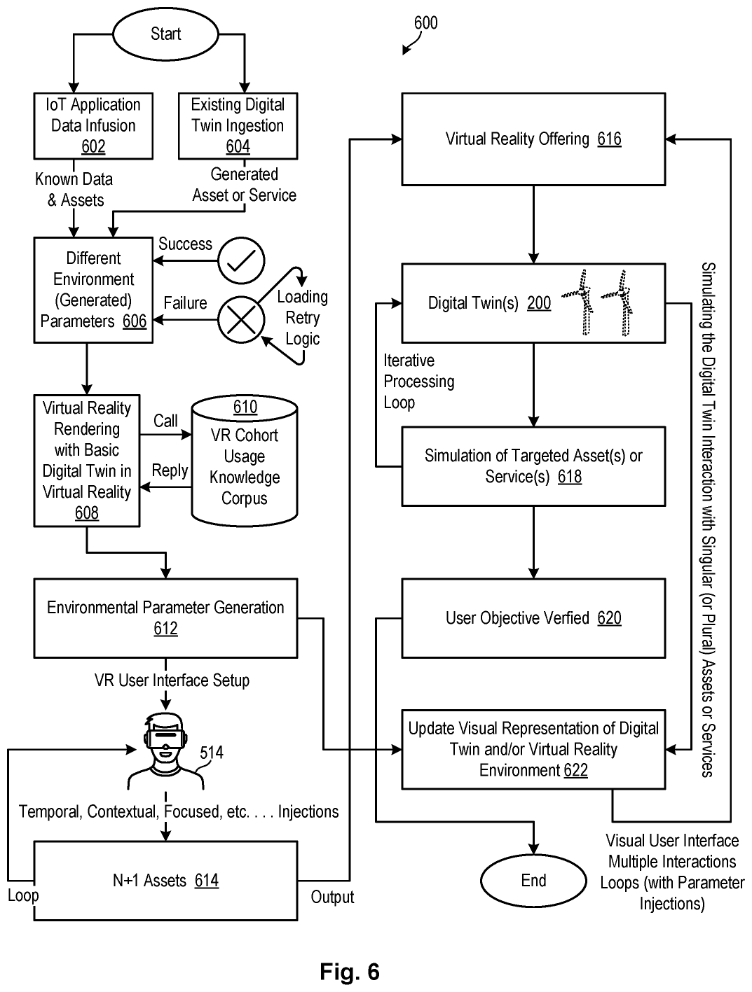

Referring to FIG. 6, a flow diagram showing a more detailed process 600 in accordance with the invention is illustrated. As shown, the process 600 may start with data, namely IoT (Internet of Things) application data infusion 602, which may include data 602 gathered from Internet-connected sensors associated with a particular physical asset 202 or assets 202. This data may also include data 604 that is ingested by an existing digital twin 200. In general, the step 606 may attempt to import all needed data from existing physical assets 202 and digital twins 200 in order to perform the disclosed simulation techniques. At step 608, the method 600 may attempt to import, from a knowledge corpus 610, any historical data that may exist with respect to the physical assets 202 or digital twins 200 that are going to be simulated. This may include past simulation data or testing that was performed for the physical assets 202 and/or digital twins 200.

At step 612, the method 500 may generate 612 operational parameter 502 that may be used in the virtual reality environment 300 for simulating the digital twins 200. A virtual reality user interface may also be set up for the user 514. The user 514 may then import 614 the digital twin 200 or twins 200 into the virtual reality environment 300 with the operational parameter 502 established at step 612. As shown, the process 600 may loop at step 614 until all desired digital twins 200 are brought into the virtual reality environment 300. Once all digital twins 200 are imported into the virtual reality environment 300, the user 514 may be presented with a virtual reality offering at step 616 that includes the virtual reality environment 300 with the one or more digital twins 200 visually represented therein. In essence, steps 602, 604, 606, 608, 612, 614, 616 are used to set up or prepare an environment in a virtual reality device such as a virtual reality headset to enable a user 514 to simulate the digital twins 200 in the virtual reality environment 300.

Once the environment is set up, the user 514 may then begin to simulate 618 the digital twin 200 or twins 200 in the virtual reality environment 300. As shown in FIG. 6, this may be an iterative process. For example, the user 514 may simulate the digital twin(s) 200 in the virtual reality environment 300 with a certain set of operational parameters 502 to determine how the digital twin(s) 200 will perform, and then modify the operational parameters 502 to see how the digital twin(s) 200 will perform under a different set of conditions. For example, using the wind turbine example provided above, the user 514 may iteratively modify one or more of the wind speed, temperature, precipitation, and the like in the virtual reality environment 300 to see how the wind turbine performs under different conditions.

In other cases, the user 514 may alternatively or additionally iteratively modify characteristics of the digital twin(s) 200 to see how they will perform in the virtual reality environment 300. For example, using the wind turbine example again, the height, number of blades, shape of blades, orientation of the wind turbine, or the like, may be modified to see how the wind turbine will perform in the virtual reality environment 300 under different operational parameters 502. Thus, in certain embodiments, the simulation may be iteratively performed for different digital twin characteristics as well as different virtual reality environment operational parameters 502. This may be done until a user objective is verified at step 620. This user objective may in certain embodiments be a desired result the user is looking to achieve. Each time digital twin characteristics and/or operational parameters 502 of the virtual reality environment 300 are established or modified, a visual representation of the digital twin 200 and/or virtual reality environment 300 may be updated at step 622.

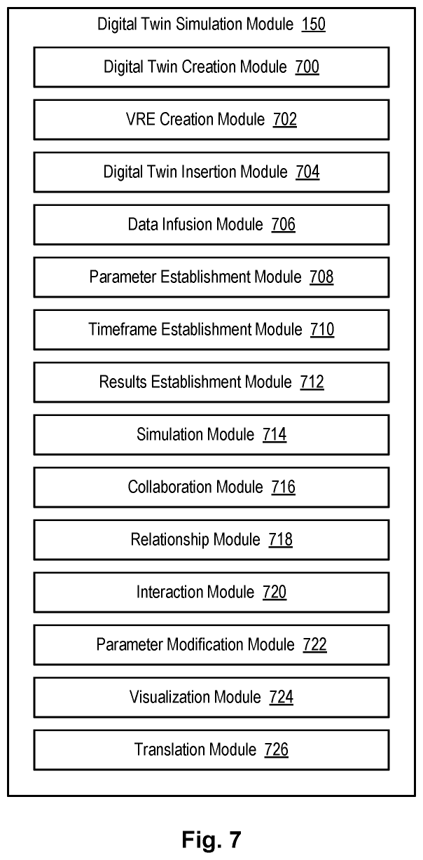

Referring to FIG. 7, a high-level block diagram showing a digital twin simulation module 150 and various sub-modules that may be included therein are illustrated. The digital twin simulation module 150 and associated sub-modules may be implemented in hardware, software, firmware, or combinations thereof. The digital twin simulation module 150 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

As shown, the digital twin simulation module 150 may include one or more of a digital twin creation module 700, virtual reality environment creation module 702, digital twin insertion module 704, data infusion module 706, parameter establishment module 708, timeframe establishment module 710, results establishment module 712, simulation module 714, collaboration module 716, relationship module 718, interaction module 720, parameter modification module 722, visualization module 724, and translation module 726.

As shown in FIG. 7, the digital twin simulation module 150 may be configured to simulate a digital twin 200 or twins 200 in a virtual reality environment 300. To accomplish this, a digital twin creation module 700 may be configured to provide or create a digital twin 200 of a physical asset 202. The virtual reality environment (VRE) creation module 702, by contrast, may be configured to provide or create a virtual reality environment 300 into which the digital twin 200 may be inserted. In certain embodiments, the virtual reality environment 300 is one suited to the physical asset 202 and reflects a real-world environment into which a corresponding physical asset 202 would be suited or is already operating. The digital twin insertion module 704 may then insert the digital twin 200 into the virtual reality environment 300 at a place or location in the virtual reality environment 300 where the digital twin's performance or operational effectiveness may be realistically simulated.

In certain embodiments, a data infusion module 706 may infuse data such as sensor data from the associated physical asset 202 into the digital twin 200 in the virtual reality environment 300. Similarly, the parameter establishment module 708 may be used to set operational parameters 502 in the virtual reality environment 300. For example, in the wind turbine example provided above, the operational parameters 502 may include temperature, wind speed, wind direction, precipitation characteristics, and the like, within the virtual reality environment 300.

The timeframe establishment module 710 may establish a time frame or period over which the digital twin 200 is exposed to the operational parameters 502 and/or is tested or simulated within the virtual reality environment 300. The results establishment module 712, by contrast, may identify the results of a simulation of a digital twin 200 within the virtual reality environment 300. Alternatively, the relationship module 718 may enable a user 514 to designate desired results of a digital twin 200 within the virtual reality environment 300, and characteristics of the digital twin 200 and/or the operational parameters 502 of the virtual reality environment 300 may be iteratively adjusted to achieve the desired results.

The simulation module 714 may be configured to simulate operation of the digital twin 200 in the virtual reality environment 300 using the operational parameters 502 discussed above. In certain embodiments, this simulation is an iterative process. For example, the digital twin 200 may be simulated in the virtual reality environment 300 for different operational parameters 502 to determine how the digital twin 200 performs under different conditions. In certain embodiments, the parameter modification module 722 may be used to modify the operational parameters 502. In other or the same embodiments, the digital twin 200 may be simulated for different characteristics of the digital twin 200 (e.g., in the wind turbine example, turbine height, blade length, number of blades, blade width, etc.) to determine the operation effectiveness of the digital twin 200 with different characteristics.

The collaboration module 716 may enable multiple digital twin models 200 to be placed in the virtual reality environment 300 together. These digital twins 200 may be identical or different. The relationship module 718 may be used to establish relationships between the multiple digital twins 200 in the virtual reality environment 300. For example, the output of one digital twin 200 may provide an input to another digital twin 200 or the operation of one digital twin 200 may affect and/or be affected by the operation of another digital twin 200. The interaction module 720 may establish how digital twins 200 interact with one another, and/or determine or analyze the interaction between the digital twins 200 that have been placed in the virtual reality environment 300 where the interaction may be unknown.

The visualization module 724 may assist a user 514 in visualizing the one or more digital twins 200 within the virtual reality environment 300. In certain embodiments, a virtual reality device, such as a virtual reality headset, may enable the user 514 to observe the operation and performance of digital twins 200 in the virtual reality environment 300, and/or observe how the digital twins 200 interact with one another, and/or how the digital twins 200 perform or change over time. In certain embodiments, the virtual reality device may enable the user 514 to move around within the virtual reality environment 300 and/or change a viewing angle of the digital twins 200 within the virtual reality environment 300.

In certain embodiments, a translation module 726 may translate content within the virtual reality environment 300 into a user's preferred language. In other embodiments, the translation module 726 may convert information into other forms, such as from written text or symbols to spoken text or symbols or sounds to assist those with special needs to use the virtual reality device.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method comprising:
providing a first digital twin model of a first physical object;
establishing a virtual reality environment for simulating operation of the first digital twin model;
operating the first digital twin model in the virtual reality environment;
receiving, by the first digital twin model, operational parameters from the virtual reality environment to determine operational effectiveness of the first digital twin model in operating within the virtual reality environment; and
enabling a user to visualize the operation of the first digital twin model in the virtual reality environment.

2. The method of claim 1, further comprising providing a second digital twin model of a second physical object.

3. The method of claim 2, further comprising operating the second digital twin model in the virtual reality environment along with the first digital twin model.

4. The method of claim 3, further comprising enabling interaction between the first digital twin model and the second digital twin model in the virtual reality environment.

5. The method of claim 3, further comprising enabling operation of the first digital twin model in the virtual reality environment to affect operation of the second digital twin model in the virtual reality environment.

6. The method of claim 1, wherein enabling a user to visualize comprises enabling a user to visualize on a virtual reality device.

7. The method of claim 1, further comprising enabling a user to control the operational parameters in the virtual reality environment.

8. A computer program product comprising a computer-readable storage medium having computer-usable program code embodied therein, the computer-usable program code configured to perform the following when executed by at least one processor:
provide a first digital twin model of a first physical object;
establish a virtual reality environment for simulating operation of the first digital twin model;
operate the first digital twin model in the virtual reality environment;
receive, by the first digital twin model, operational parameters from the virtual reality environment to determine operational effectiveness of the first digital twin model in operating within the virtual reality environment; and
enable a user to visualize the operation of the first digital twin model in the virtual reality environment.

9. The computer program product of claim 8, wherein the computer-usable program code is further configured to provide a second digital twin model of a second physical object.

10. The computer program product of claim 9, wherein the computer-usable program code is further configured to operate the second digital twin model in the virtual reality environment along with the first digital twin model.

11. The computer program product of claim 10, wherein the computer-usable program code is further configured to enable interaction between the first digital twin model and the second digital twin model in the virtual reality environment.

12. The computer program product of claim 10, wherein the computer-usable program code is further configured to enable operation of the first digital twin model in the virtual reality environment to affect operation of the second digital twin model in the virtual reality environment.

13. The computer program product of claim 8, wherein enabling a user to visualize comprises enabling a user to visualize on a virtual reality device.

14. The computer program product of claim 8, wherein the computer-usable program code is further configured to enable a user to control the operational parameters in the virtual reality environment.

15. A system comprising:
at least one processor;
at least one memory device operably coupled to the at least one processor and storing instructions for execution on the at least one processor, the instructions causing the at least one processor to:
provide a first digital twin model of a first physical object;
establish a virtual reality environment for simulating operation of the first digital twin model;
operate the first digital twin model in the virtual reality environment;
receive, by the first digital twin model, operational parameters from the virtual reality environment to determine operational effectiveness of the first digital twin model in operating within the virtual reality environment; and
enable a user to visualize the operation of the first digital twin model in the virtual reality environment.

16. The system of claim 15, wherein the instructions further cause the at least one processor to provide a second digital twin model of a second physical object.

17. The system of claim 16, wherein the instructions further cause the at least one processor to operate the second digital twin model in the virtual reality environment along with the first digital twin model.

18. The system of claim 17, wherein the instructions further cause the at least one processor to enable interaction between the first digital twin model and the second digital twin model in the virtual reality environment.

19. The system of claim 17, wherein the instructions further cause the at least one processor to enable operation of the first digital twin model in the virtual reality environment to affect operation of the second digital twin model in the virtual reality environment.

20. The system of claim 15, wherein the instructions further cause the at least one processor to enable a user to control the operational parameters in the virtual reality environment.
